(19) United States
(12) Patent Application Publication
(10) Pub. No.: US 2012/0014241 A1
(43) Pub. Date: Jan. 19, 2012

(54) APPARATUS FOR VIBRATION REDUCTION IN A HARD DISK DRIVE

(76) Inventors: Teck Hong Yip, Singapore (SG); Zhi Min He, Singapore (SG); Cheng Peng Tan, Singapore (SG); Chong Wee Lee, Singapore (SG)

(21) Appl. No.: 13/257,974

(22) PCT Filed: Mar. 17, 2010
(86) PCT No.: PCT/SG2010/000098

§ 371 Date: Sep. 20, 2011

(30) Foreign Application Priority Data
Mar. 20, 2009 (SG) 200902026-4

(51) Int. Cl. G11B 21/16

(52) U.S. Cl. 369/247.1; G9B/21.023

(57) ABSTRACT

An apparatus for vibration reduction in a hard disk drive, the hard disk drive comprising at least one hard disk and at least one actuator arm. The apparatus comprises a flow mitigating device disposed on the at least one actuator arm, the flow mitigating device comprising at least one surface being inclined with respect to a reference plane of the actuator arm to generate streamwise vortices for interacting with and weakening vortex structures generated at a trailing edge of the actuator arm during spinning of the hard disk.

### FIELD OF THE INVENTION

The invention relates to an apparatus for vibration reduction in a hard disk drive and particularly, though not exclusively, relates to an apparatus for suppressing flow induced vibrations on a hard disk drive actuator arm.

### BACKGROUND

Flow induced vibration (FIV) in hard disk drives (HDDs) is one of the major causes of magnetic head positioning error, leading to track mis-registration. This is particularly so for higher rpm types of hard disk drives. As a consequence, FIV constitutes a significant proportion of non-repeatable run-out budget during the design stage of such higher rpm hard disk drives. Most, if not all, disturbances in higher rpm (>10K rpm) enterprise class hard disk drives come from FIV.

FIV suppressions in production hard disk drives is currently achieved by restricting the volume of high velocity air impinging onto the actuator. This may be by use of an air separator 3 as shown in FIG. 1 (a) (Prior Art), or air stabilizing wings 5 as shown in FIG. 1 (b) (Prior Art). With the use of the air separator 3 or air stabilizing wings 5, a major side-effect is accompanying air drag opposing disk rotation. The opposing drag was estimated to increase 20% by Kirpekar & Bogy (2006).

Tests showed that a 15 k rpm Cheetah drive fitted with 4 pieces of air separators needs about 2.4 watt of motor power to overcome fluid drag. A typical enterprise drive needs about 10 watts to operate, so 24% or about one quarter of input power to the hard disk drive is wasted on overcoming fluid drag. It also leads to a hefty increase in motor power consumption inside the hard disk drive. In addition, the additional motor power would have to be dissipated away as heat, giving rise to further heat reliability problems.

### SUMMARY OF THE INVENTION

According to a first exemplary aspect, there is provided an apparatus for vibration reduction in a hard disk drive, the hard disk drive comprising at least one hard disk and at least one actuator arm. The apparatus comprises a flow mitigating device disposed on the at least one actuator arm, the flow mitigating device comprising at least one surface being inclined with respect to a reference plane of the actuator arm to generate streamwise vortices for interacting with and weakening vortex structures generated at a trailing edge of the actuator arm during spinning of the hard disk.

The flow mitigating device is preferably located on the actuator arm where trailing edge vortex structures are likely to appear during rotation of the hard disk.

The flow mitigating device preferably projects from a trailing edge of the actuator arm, and is preferably integral with the actuator arm.

The flow mitigating device may have a triangular shape having a base and a height, wherein aspect ratio of the base to the height ranges from 2:3 to 3:1

The reference plane may be a planar face of the actuator arm, the planar face being substantially parallel to the hard disk.

The flow mitigating device may comprise at least one pair of projections. A first projection of the pair of projections is preferably inclined at an acute angle with respect to the planar face, and a second projection of the pair of projections is preferably inclined at a reflex angle greater than 270° with respect to the planar face. Peak to peak distance between the first projection and the second projection is preferably less than or equal to two times a thickness of the plate. The pair of projections preferably define an angle therebetween ranging from 5° to 175°.

The apparatus may further comprise at least a second pair of projections on the actuator arm, wherein a distance between the first pair of projections and the second pair of projections is determined by the size of a vortex shedding region behind the trailing edge. A total number of pairs of projections on the actuator arm is preferably dependent on a size of a vortex shedding region behind the trailing edge.

According to a second aspect, there is provided an actuator arm for a hard disk drive comprising the apparatus for vibration reduction of the first aspect.

According to a third aspect, there is hard disk drive comprising an actuator arm of the second aspect.

### BRIEF DESCRIPTION OF THE DRAWINGS

In order that the invention may be fully understood and readily put into practical effect there shall now be described by way of non-limitative example only exemplary embodiments of the present invention, the description being with reference to the accompanying illustrative drawings.

In the drawings:

FIG. 1(a) (prior art) is a plan view of a hard disk drive with an air separator (taken from US Patent Application Publication No. 2006114603);

FIG. 1(b) (prior art) is a plan and perspective view of a hard disk drive with air stabilizing wings (taken from U.S. Pat. No. 6,449,119);

FIG. 2(a) is a schematic perspective view of an exemplary embodiment of a flow mitigating device on an actuator arm;

FIG. 2(b) is a close-up view of the flow mitigating device of FIG. 2(a);

FIG. 2(c) is a side view of the flow mitigating device of FIG. 2(b);

FIG. 3(a) is a perspective view of an exemplary embodiment of a flow mitigating device on an actuator arm;

FIG. 3(b) is a stream-wise view (air flow direction towards reader) of the flow mitigating device and resultant vortex structures of the flow mitigating device of FIG. 3(a);

FIG. 4 is a graph of a vibration velocity spectrum at an inner diameter of disks in a drive;

FIG. 5 is a graph of a vibration velocity spectrum at a middle diameter of the disks of FIG. 4;

FIG. 6 is a graph of a vibration velocity spectrum at an outer diameter of the disks of FIG. 4;

FIG. 7 is a table of input power required to spin a hard drive with and without the flow mitigating device of FIG. 2;

FIG. 8(a) is a perspective view of an alternative exemplary flow mitigating device disposed in a recess of an actuator arm;

FIG. 8(b) is a close-up view of the flow mitigating device of FIG. 8(a);

FIG. 9(a) is a perspective view of a further alternative exemplary flow mitigating device integrally disposed on an actuator arm;

FIG. 9(b) is a close-up view of the flow mitigating device of FIG. 9(a);

FIG. 10(a) is a perspective close-up view of a flow mitigating device comprising pairs of projections in the shape of rectangles;

FIG. 10(b) is a perspective close-up view of a flow mitigating device comprising pairs of projections in the shape of semicircles;

FIG. 11(a) is a perspective view of another exemplary flow mitigating device comprising surfaces inclined with respect to a trailing edge of the actuator arm;

FIG. 11(b) is a close-up view of the flow mitigating device of FIG. 11(a);

FIG. 12(a) is a perspective view of yet another exemplary flow mitigating device comprising a single projection disposed on a planar face and on a trailing half of the actuator arm; and

FIG. 12(b) is a close-up view of the flow mitigating device of FIG. 12(a).

### DETAILED DESCRIPTION OF THE EXEMPLARY EMBODIMENTS

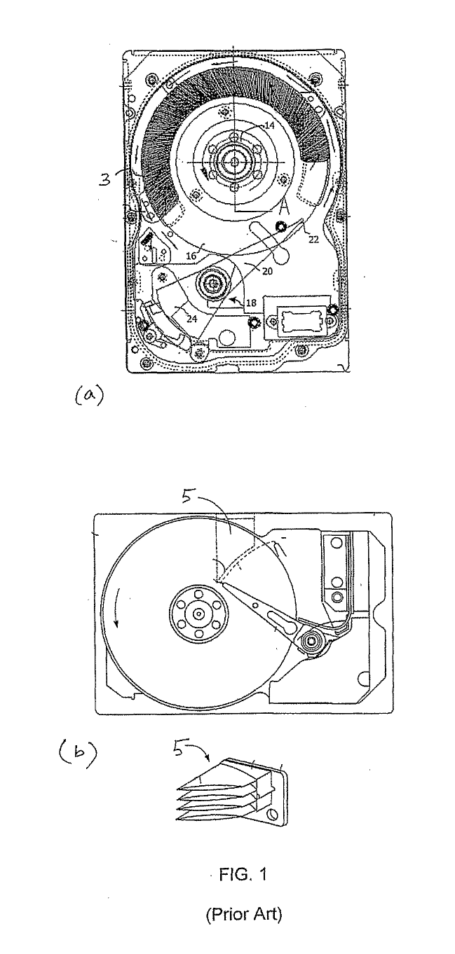

An exemplary apparatus for reducing vibration in a hard disk drive comprising at least one hard disk and at least one actuator arm will be described with reference to FIGS. 1 to 12.

The apparatus comprises a passive flow mitigating device 8 for suppressing airflow induced vibrations in a hard disk drive actuator 11 during operation without inducing air drag that opposes disk rotation. The actuator 11 may comprise multiple actuator arms 14. Each actuator arm 14 may include a head suspension assembly 13.

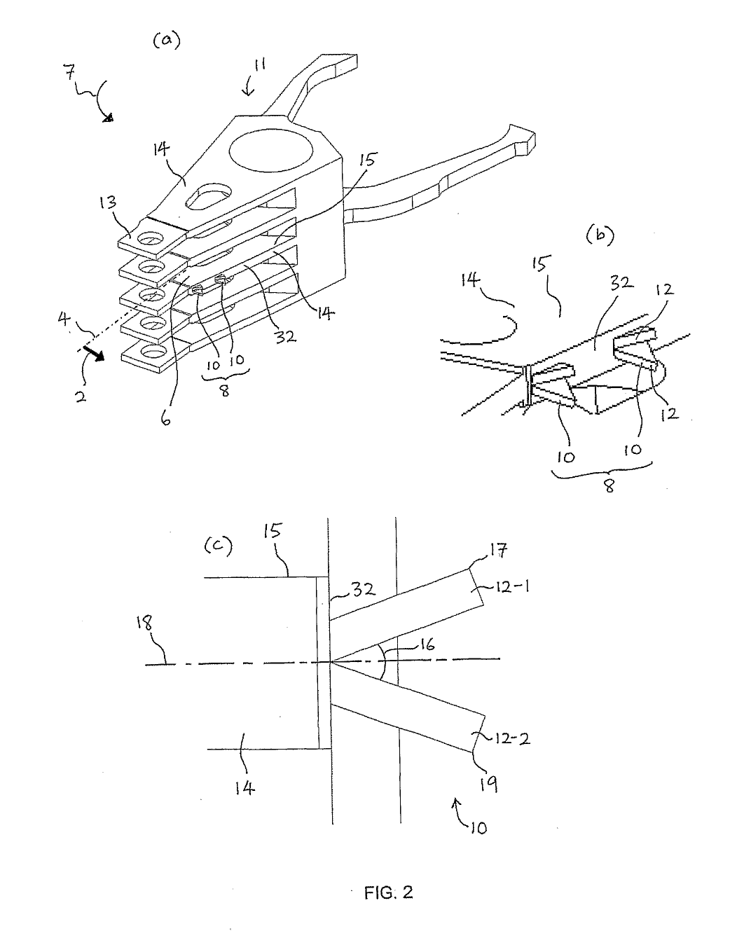

As shown in FIG. 2 (a), the flow mitigating device 8 is disposed on a trailing half 6 of an actuator arm 14 as indicated by arrows 2 from a longitudinal mid-line 4 of the actuator arm 14. The trailing half 6 is a portion of the actuator arm 14 that is further away from on-coming airflow indicated by arrow 7 during operation. The flow mitigating device 8 should have at least one surface 9 being inclined with respect to a reference plane of the actuator arm 14. The reference plane could be any one of the surfaces of the actuator arm 14, for example, the reference plane could be a planar face 15 that is parallel to a hard disk or a trailing edge 32 that is a face perpendicular to the hard disk.

The flow mitigating device 8 preferably comprises at least a pair 10 of protrusions or projections 12 disposed on the actuator arm 14, and is preferably located on a trailing edge 32 of the actuator arm 14. The trailing edge 32 faces away from on-coming airflow indicated by arrow 7 against the actuator arm 14. The projections 12 may be separate elements connected to the actuator arm 14. Alternatively, the projections 12 may be integrally formed as part of the actuator arm 14, such as cast as a single unit or machined from a larger element as shown in FIG. 9.

Preferably, each projection 12 is triangular in shape and disposed on the actuator arm 14 such that a pair 10 of projections 12 resembles a bird's beak projecting from the actuator arm 14. In this embodiment, the reference plane with respect to which a surface 9 of the flow mitigating device 8 is inclined is the planar face 15 of the actuator arm 14 that is substantially parallel to a hard disk. Accordingly, each projection 12 is inclined with respect to the planar face 15 of the actuator arm 14. Preferably, for each pair 10 of projections 12, a first projection 12-1 is inclined at an acute angle with respect to the planar face 15 while a second projection 12-2 is inclined at a reflex angle greater than 270° with respect to the planar face 15.

The projections 12 are preferably placed symmetrically about a plane of symmetry 18 parallel to the planar face 15. This plane of symmetry 18 is a centrally positioned axial plane 18 of the actuator arm 14. The number of pairs 10 of projections 12 to be formed on the actuator arm 14 is dependent on the size of the vortex shedding region behind the trailing edges 32 of the actuator arm 14, which in turn is dependent on the hard disk drive design.

At least one pair 10 of projections 12 per arm 14 is preferably provided. In the embodiment shown in FIGS. 2 (a) to (c), two pairs 10 of projections 12 are provided on the actuator arm 14. The maximum number of pairs 10 of projections 12 is limited only by the dimension of the actuator arm 14. Distance between each pair 10 of projections 12 is determined by the size of the vortex shedding region. Each projection 12 can have the shape of any type of triangle having a base and a height, e.g. isosceles, scalene, equilateral and all other types of triangles. The aspect ratio of the base to height of the triangle preferably ranges from 2:3 to 3:1. The angle 16 between two projections 12 that form a pair 10 resembling a bird's beak may range widely from 5° to 175°, as shown in FIG. 2 (c). The peak 17 to peak 19 distance or separation is preferably not more than 2 times the thickness of the actuator arm 14.

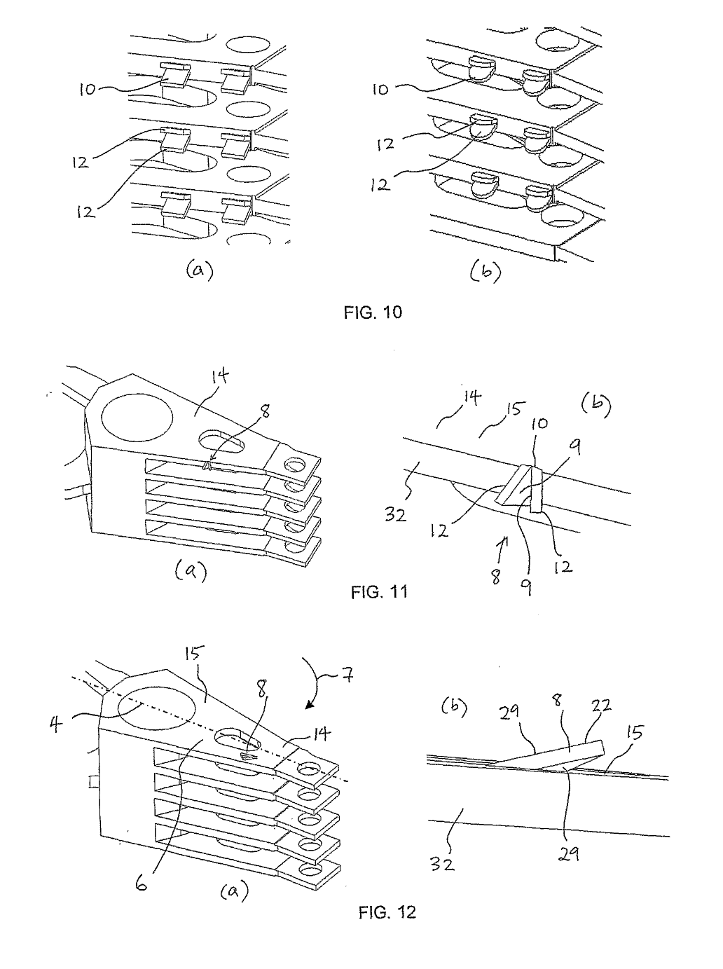

In an alternative embodiment of the flow mitigating device 8 as shown in FIG. 8, each pair 10 of projections 12 may be disposed in a recess 40 provided on the trailing edge 32 of the actuator arm 14. In other embodiments, each pair 10 of projections 12 may have other shapes than triangles, for example, they may be rectangles or semicircles as shown in FIGS. 10 (a) and (b) respectively.

In yet another embodiment of the flow mitigating device 8 as shown in FIG. 11, the pair 10 of projections 12 is disposed on the actuator arm 14 such that at least one surface 9 of the flow mitigating device 8 is inclined with respect to the trailing edge 32 instead of the planar face 15.

In a further alternative embodiment shown in FIG. 12, the flow mitigating device 8 comprises a single projection 22 disposed on the planar face 15 and on the trailing half 6 of an actuator arm 14. The singe projection 22 has at least one surface 29 inclined with respect to the planar face 15.

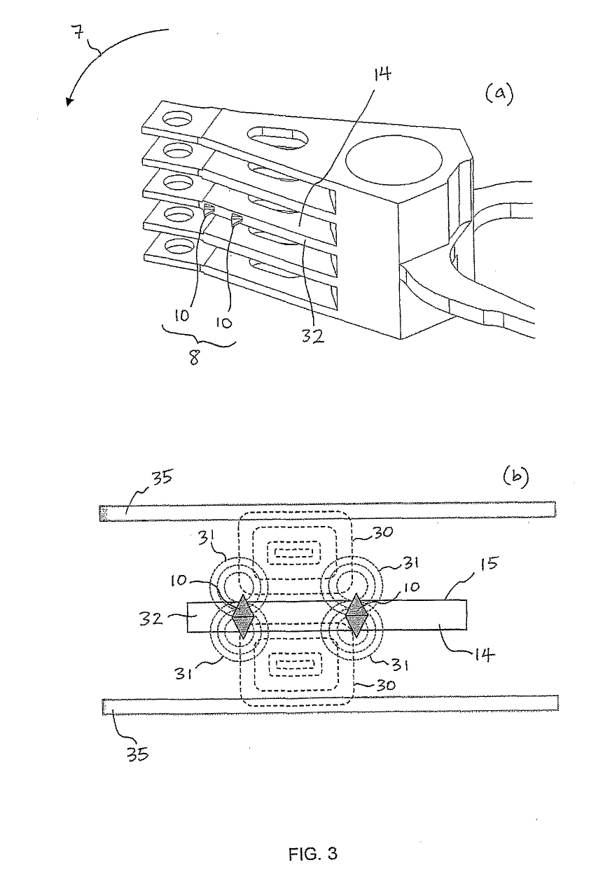

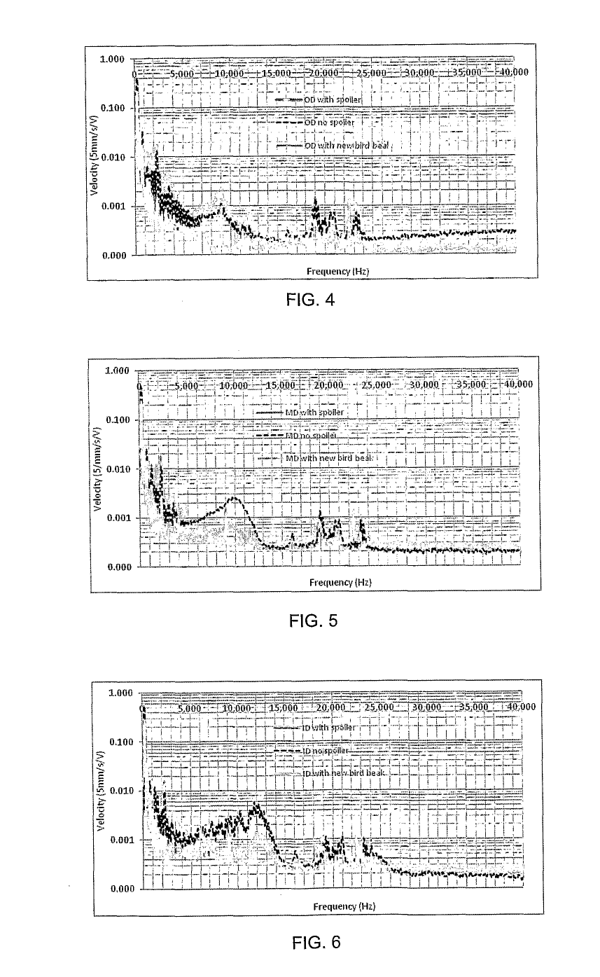

As shown in FIG. 3 (b), the flow mitigating device 8 should be placed close to where trailing edge vortex structures 30 would be likely to appear during operation of the hard disk drive. Consequently, placement of the flow mitigating device 8 should avoid any part of the actuator arm 14 that extends out of the air space enveloped by the walls of the rotating disks 35, where vortex shedding is unlikely to occur. Preliminary studies into hard disk drive flow fields have revealed complex vortex shedding phenomenon behind the trailing edges 32 of the actuator arms 14 and FIV were attributed to these vortical structures 30. The leading edges 33 and trailing edges 32 are defined by the stream-wise direction 7 as shown in FIG. 3(a), wherein the air stream flows past leading edges 33 first before flowing over the body of the actuator arm 14 and then past the trailing edge 32. Flow structures also change with increasing disk rpm. The flow mitigating device 8 functions to generate streamwise vortices 31 that interact with the trailing edge vortex structures 30. Consequently, the trailing edge flow structures 30 are significantly weakened in the streamwise direction 34. Fluid forces imposed on the solid actuator arm 14 are correspondingly weakened, resulting in reduced vibration. To determine the efficacy of the flow mitigating device 8, in-plane vibrations of a actuator 24 on a product hard disk drive were evaluated using Laser Doppler vibrometer (LDV) measurements. LDV tests were run with the actuator 24 positioned at an inner diameter (ID), middle diameter (MD) and outer diameter (OD) of the hard disks. The vibration velocity spectra obtained using the LDV are shown in FIGS. 4 to 6, demonstrating that the flow mitigating device 8 is able to suppress the FIV on the actuator.

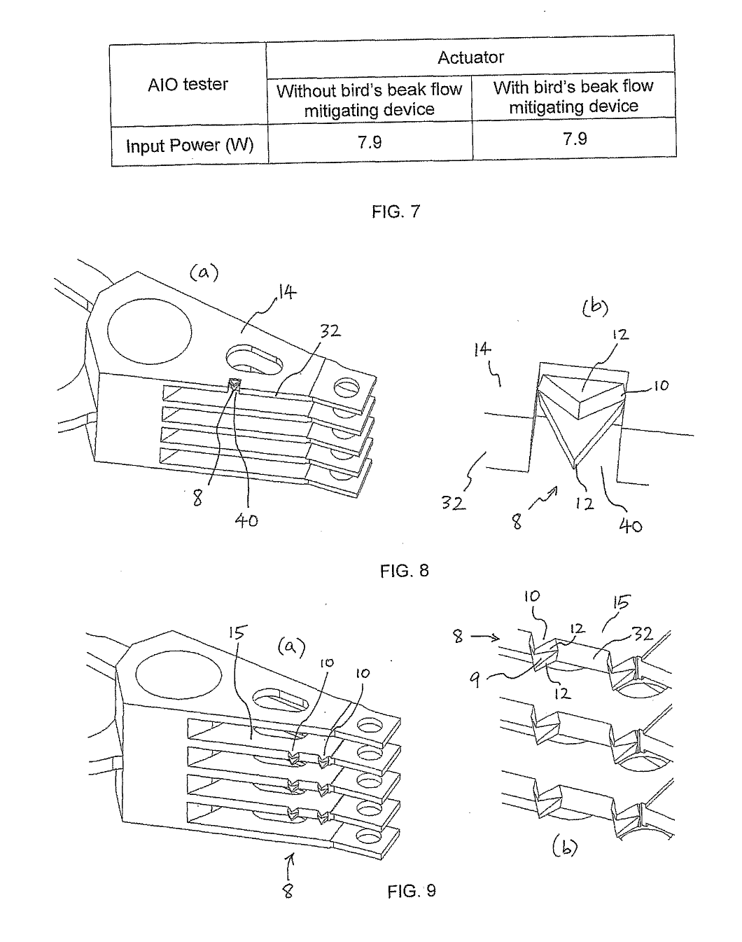

Flow drag generated by the flow mitigating device 8 was also evaluated using the same 3.5 inch format hard drive described above. Input power required to spin the circular disks 28 at 15K rpm having a actuator 24 with and without the flow mitigating device 8 was compared, as shown in the table of FIG. 7. As can be seen, no additional flow drag was induced by provision of the flow mitigating device 8 on the actuator 24.

Whilst there has been described in the foregoing description exemplary embodiments of the present invention, it will be understood by those skilled in the technology concerned that many variations in details of design, construction and/or operation may be made without departing from the present invention.

1. An apparatus for vibration reduction in a hard disk drive, the hard disk drive comprising at least one hard disk and at least one actuator arm, the apparatus comprising:
a flow mitigating device disposed on the at least one actuator arm, the flow mitigating device comprising at least one surface being inclined with respect to a reference plane of the actuator arm to generate streamwise vortices for interacting with and weakening vortex structures generated at a trailing edge of the actuator arm during spinning of the hard disk to thereby weaken fluid forces imposed on the actuator arm.

2. The apparatus of claim 1, wherein the flow mitigating device is located on the actuator arm where trailing edge vortex structures are likely to appear during rotation of the hard disk.

3. The apparatus of claim 1, wherein the flow mitigating device projects from a trailing edge of the actuator arm.

4. The apparatus of claim 1, wherein the flow mitigating device is integral with the actuator arm.

5. The apparatus of claim 1, wherein the flow mitigating device has a triangular shape having a base and a height.

6. The apparatus of claim 5, wherein aspect ratio of the base to the height ranges from 2:3 to 3:1

7. The apparatus of claim 1, wherein the reference plane is a planar face of the actuator arm, the planar face being substantially parallel to the at least one hard disk.

8. The apparatus of claim 1, wherein the flow mitigating device comprises at least one pair of projections.

9. The apparatus of claim 1, wherein the flow mitigating device comprises at least one pair of projections, a first projection of the pair of projections being inclined at an acute angle with respect to the planar face, and a second projection of the pair of projections being inclined at a reflex angle greater than 270° with respect to the planar face.

10. The apparatus of claim 8, wherein peak to peak distance between the first projection and the second projection is less than or equal to two times a thickness of the actuator arm.

11. The apparatus of claim 8, wherein the pair of projections define an angle there between ranging from 5° to 175°.

12. The apparatus of claim 8, further comprising at least a second pair of projections on the actuator arm, wherein a distance between the first pair of projections and the second pair of projections is determined by the size of a vortex shedding region behind the trailing edge.

13. The apparatus of claim 8, wherein a total number of pairs of projections on the actuator arm is dependent on a size of a vortex shedding region behind the trailing edge.

14. An actuator arm for a hard disk drive comprising an apparatus for vibration reduction in the hard disk drive, the hard disk drive comprising at least one hard disk, the apparatus comprising:
a flow mitigating device disposed on the actuator arm, the flow mitigating device comprising at least one surface being inclined with respect to a reference plane of the actuator arm to generate streamwise vortices for interacting with and weakening vortex structures generated at a trailing edge of the actuator arm during spinning of the hard disk to thereby weaken fluid forces imposed on the actuator arm.

15. A hard disk drive comprising an actuator arm comprising an apparatus for vibration reduction in the hard disk drive, the hard disk drive comprising at least one hard disk, the apparatus comprising:
a flow mitigating device disposed on the actuator arm, the flow mitigating device comprising at least one surface being inclined with respect to a reference plane of the actuator arm to generate streamwise vortices for interacting with and weakening vortex structures generated at a trailing edge of the actuator arm during spinning of the hard disk to thereby weaken fluid forces imposed on the actuator arm.
